(19) United States
(12) Patent Application Publication
(10) Pub. No.: US 2010/0295726 A1
(43) Pub. Date: Nov. 25, 2010

(54) GLOBAL POSITIONING SYSTEM ERROR CORRECTION, VEHICLE TRACKING AND OBJECT LOCATION

(76) Inventor: Phillip Tann, Newcastle (GB)

Correspondence Address: Zilka-Kotab, PC, P.O. BOX 721120, SAN JOSE, CA, 95172-1120, US

(21) Appl. No.: 12/602,065

(22) PCT Filed: May 27, 2008
(86) PCT No.: PCT/GB2008/001805

§ 371 Date: Jul. 13, 2010

(30) Foreign Application Priority Data
May 26, 2007 (GB) 0710126.4

(51) Int. Cl. G01S 19/41

(52) U.S. Cl. 342/357.24

(57) ABSTRACT

A method and computer program for determining an error factor for a differential global positioning system is disclosed as well as a method of tracking a vehicle. In determining the error factor, estimated positional data is transmitted from a GPS via GPRS to a server. Since the GPS signals are being transmitted from a vehicle travelling along a known route, i.e. a road or rail track, the data can be matched to the route and a correction factor calculated. The error factor is then transmitted to differential GPS devices. For vehicle tracking a global positioning system sends, via GPRS, data a regular intervals relating only to its position.

The present invention relates to a method of correcting errors in determining the location of a GPS receiver and to a method for tracking vehicles using a GPS receiver and relates particularly, but not exclusively, to such methods using mobile telephone networks to receive and disseminate such data. The invention also relates to a method and apparatus for locating an object.

The use of global positioning system (GPS) devices to determine the location of the device is well known. GPS uses signals transmitted from satellites to triangulate and determine a position that the signals were received. This is done by determining the distance that a signal has traveled from the satellite to the GPS receiver, the distance being determined from the time that the signal has taken to travel multiplied by the speed of light. However, the speed of light is only constant within a vacuum and therefore as the GPS signal passes through the ionosphere and troposphere it changes its path bouncing off ice and charged particles. These errors mean that a standard GPS receiver can determine its position to within around ten metres.

In order to overcome this problem an error correction service, known as differential global positioning system (DGPS), uses a series of GPS reference stations at fixed known locations. The exact position of these locations is known and therefore the difference between the calculated position, by a GPS receiver at that location, can be determined. This error factor is then transmitted to DGPS receivers that can then use this error factor to improve their estimation of their present location. DGPS typically has an accuracy of around four metres. However, building and installing reference stations is expensive and in the UK they are located approximately every 200 kilometres. As a result, such DGPS stations are unable to accommodate local inaccuracies. For example, GPS signals bouncing off tall buildings can cause significant errors in built up areas where it is also often the case that roads can be separated by very short distances leading to a GPS receiver indicating that it is located at a position on a different road than it is really located.

Where GPS receivers are used in conjunction with a mobile phone network transmitter, typically a general packet radio service (GPRS) transmitter, to track vehicles, a large amount of data relating to the position, direction of travel and speed of travel of a vehicle are transmitted to a tracking station, typically by SMS message. Because of the low frequency with which the information is sent it is difficult to build up an accurate picture of the movement of the vehicle or to determine patterns in driving and in driver technique.

Preferred embodiments of the present invention seek to overcome the above defined problems with the prior art.

According to an aspect of the present invention there is provided a method of determining an error factor for a differential global positioning system, comprising the steps of:—

receiving data transmitted from at least one device travelling along at least one of a plurality of known routes, the data relating to a plurality of assumed positions of the device on the basis of global positioning system signals received by global positioning system receiver in said device;
comparing a plurality of said assumed positions of the device with said plurality of routes to determine the route that most closely corresponds with the plurality of assumed positions; and
comparing a plurality of said assumed positions with the determined route to calculate an error factor.

By receiving a plurality of assumed positions transmitted from a device including a GPS receiver, matching these to a known route and determining an error factor, the advantage is provided that the error factor can be determined more accurately, than in the devices of the prior art, and can take into account local factors that affect the accuracy of the GPS reading. For example, the device of the present invention can eliminate localised weather factors, that have small but not insignificant impact on the accuracy of the GPS measurement that is not possible with fixed stations as widely spread as in the prior art. Furthermore, localised factors such as reflection of GPS signals on tall buildings are also accommodated and the introduction of new structures is immediately accommodated as soon as data from a device using the method of the present invention passes by that building. Also combinations of these factors are accommodated to increase the accuracy.

The method may further comprise transmitting said error factor to differential global positioning system devices.

By transmitting this data to DGPS devices, these devices are able to provide very accurate GPS readings up to an accuracy of 50 centimetres.

The method may also further comprise transmitting at least one of said data and said error factor via a mobile telephone network.

By using a mobile telephone network to transmit the error factor, the advantage is provided that very extensive coverage is already provided by the telephone network thereby allowing the increase in accuracy to be equally widely available. Furthermore, since GPS devices are often used in tracking vehicles then data is already being transmitted to and from the receiver device. Furthermore, if a vehicle is being tracked it is possible to provide a very localised error factor thereby taking into account the local conditions. For example, if a large building causes significantly different factors then as a vehicle approaches this building the error factor can be altered dynamically according to the vehicle's location.

In a preferred embodiment the error factor is expressed as a vector.

The method may further comprising:—

causing said device to travel along at least one of a plurality of known routes; and
transmitting data relating to a plurality of assumed positions of the device on the basis of global positioning system signals received by said global positioning system receiver in said device.

The method may also further comprise storing data relating to said position of said device at known intervals and said transmitted data excludes data relating to the speed and direction that the device is travelling.

By collecting and transmitting only positional data at regular intervals, the advantage is provided that only a small amount of data is produced by each vehicle that is being used to determine the GPS error factor. As a result, since it is desirable to use as many vehicles as possible to determine the accuracy over as large an area as possible, the amount of data produced, and therefore transmitting band width and processing resource required is not excessive.

According to another aspect of the present invention there is provided a computer program for determining an error factor for a differential global positioning system, the program comprising:—

first computer code for receiving data transmitted from at least one device travelling along at least one of a plurality of known routes, the data relating to a plurality of assumed positions of the device on the basis of global positioning system signals received by global positioning system receiver in said device;
second computer code for comparing a plurality of said assumed positions of the device with said plurality of routes to determine the route that most closely corresponds with the plurality of assumed positions; and
third computer code for comparing a plurality of said assumed positions with the determined route to calculate an error factor.

The computer program may further comprise fourth computer code for transmitting said error factor to differential global positioning system devices.

The computer program may also further comprising fifth computer code for transmitting at least one of said data and said error factor via a mobile telephone network.

In a preferred embodiment said third computer code calculates the error factor as a vector.

According to another aspect of the present invention there is provided a method of tracking a global positioning system receiving device, comprising the steps of:—

receiving a plurality of global positioning system signals relating to a position of said device;
storing data relating to said position of said device at known intervals in time; and
transmitting said data relating to said position of said device, said transmission including Cartesian coordinates indicating said position and excluding data relating to the speed and direction that the device is travelling or including vector coordinates indicating said position relative to a previous position and excluding Cartesian coordinates indicating said position.

By tracking a vehicle using very small amounts of data, only relating to the position of the vehicle containing the GPS receiver the advantage is provided that the reduced information that is sent is cheaper to transmit and yet can provide more information, upon analysis, than tracking systems of the prior art. For example, the position data can be used to accurately trace a position of the vehicle on a road. Since the data is recorded at known time intervals, it is easy to calculate the vehicle's speed thereby determining if speed limits have been broken. Furthermore, statistical information about driving style can be derived, for example showing rapid acceleration and deceleration of the vehicle. Using an apparatus of the present invention a vehicle travelling eight hours per day produces typically only 3 Mb of data in one month which is significantly less than seen in the prior art.

In a preferred embodiment the intervals are intervals in time.

In another preferred embodiment the intervals are determined dependent upon the distance traveled from the last stored position relative to the speed.

In a further preferred embodiment the intervals are determined such that data is stored when the distance from the last stored position measured in metres is equal to or greater than the speed measured in miles per hour.

By storing, and then transmitting data whenever the distance from the last point, measured in metres, is equal to or greater than the present speed, the data that is received by the server is very easily analysed. For example, the processing required to determine the speed at which a vehicle is travelling is significantly reduced since this is simply determined by measuring the distance between two adjacent points and that distance in metres is the speed in miles per hour that the vehicle was travelling at the second data point. Furthermore when a vehicle is travelling at a constant speed the data points are equidistant with respect to time, upon deceleration the points are closer together and upon acceleration they are further apart. It is therefore possible to derive a large amount of information from a small amount of data transmitted. However, the format that is used to transmit the data allows additional information to be easily derived without the server having to process large amounts of data which could put a significant strain on system resources when a large number of vehicles are being tracked.

In a preferred embodiment the data is transmitted via a mobile telephone network.

In another preferred embodiment the global positioning system receiving device is a differential global positioning system receiving device.

In a further preferred embodiment the differential global positioning system receiving device uses an error factor determined according to the method defined above.

According to a further aspect of the present invention, there is provided a first device for indicating the direction to at least one second device, the first device comprising:
a receiver for receiving information relating to the location of a second device;
location determining means for determining the location of the first device; calculating means for calculating the direction from the first device to the second device; and
indication means for indicating said direction.

By providing a user of the first device with a means for indicating the direction to a second device, provides the advantage of the user of the first device being able to easily locate the second device. For example, in the situation of two people trying to locate each other in a city centre, if each of them has a device according to the above invention then they will easily be able to find each other.

In a preferred embodiment the first device further comprises a transmitter for transmitting information relating to the location of the first device.

In another preferred embodiment the transmitter and the receiver comprise a single unit.

In a further preferred embodiment the indication means comprises at least one screen displaying an arrow which points in the direction of the second device.

In a preferred embodiment the indication means further indicates the distance between the first and the second devices.

In another preferred embodiment the first device is a mobile communication device.

In a further preferred embodiment the location determining means comprises a global positioning system.

In a preferred embodiment the global positioning system is a differential global positioning system.

In another preferred embodiment the differential global positioning system uses an error factor determined according to the method set out above.

This allows a user of a device of the present invention to locate another device to within 50 cm. It also improves the ease of use of the device. In a standard GPS unit, unless it is provided with an internal compass, the direction of travel can be determined when the device is moving but then when it is stationary the direction the device is pointing cannot. Therefore with a standard GPS it is necessary to move around 10 m before the device can determine the direction of travel and point in the direction of the second device. However, by using the increased accuracy of the present invention only a small movement of 50 cm is necessary.

In a further preferred embodiment the differential global positioning system uses an error factor determined using a computer program as set out above.

In a preferred embodiment the first device comprising the global positioning system is tracked according to the method set out above.

In another preferred embodiment the first device comprising the differential global positioning system is tracked according to the method set out above.

According to aspect of the present invention there is provided a method of indicating the direction from a first device to at least one second device, the method comprising the steps of:
a first device receiving information relating to the location of a second device;
determining the location of the first device;
calculating the direction from the first device to the second device; and
indicating the direction.

The method may also comprise the step of the first device transmitting information relating to the location of the first device.

The method may further comprise the step of the first device receiving information from the second device.

The method may also comprise the step of the first device receiving information from at least one fixed GPRS transmitter/receiver.

The method may further comprise the step of the first device transmitting information to the second device.

The method may also comprise the step of the first device transmitting information to at least one fixed GPRS transmitter/receiver.

The method may further comprise the step of the first device receiving information for every 0.5 meters of movement of the first device.

The method may also comprise the step of the first device transmitting information for every 0.5 meters of movement of the first device.

Preferred embodiment of the present invention will now be described, by way of example only, and not in any limitative sense, with reference to the accompanying drawings in which:—

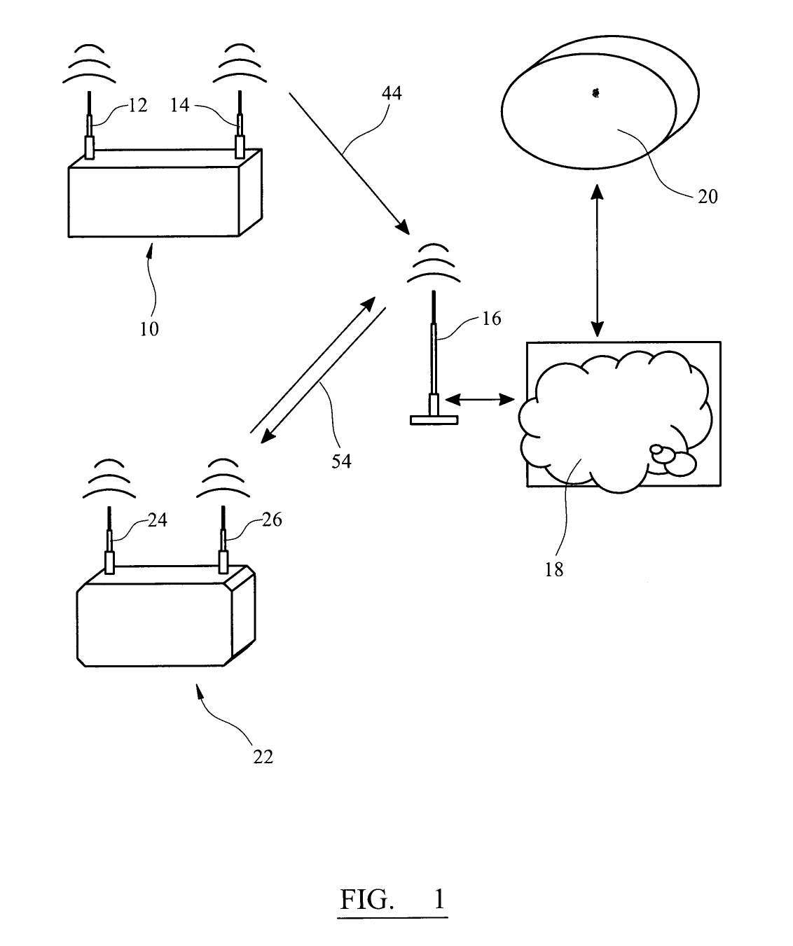

FIG. 1 is a schematic representation of apparatus used in the present invention;

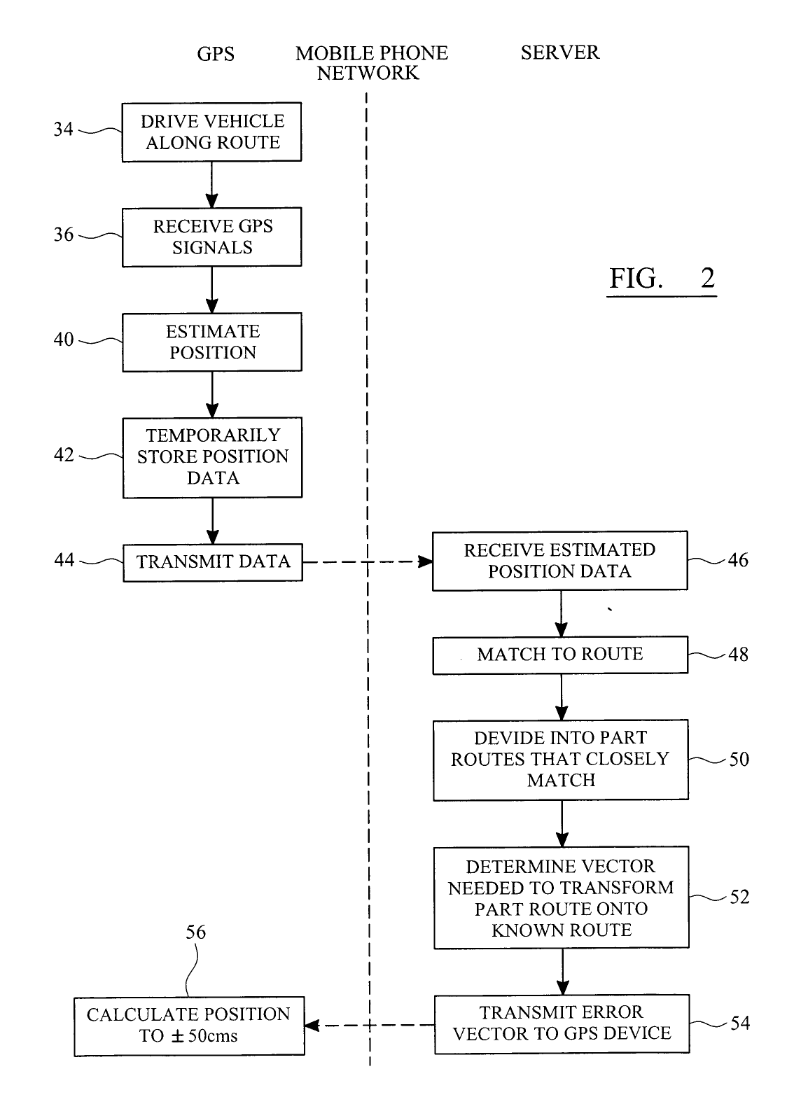

FIG. 2 is a flow chart showing the steps of the present invention;

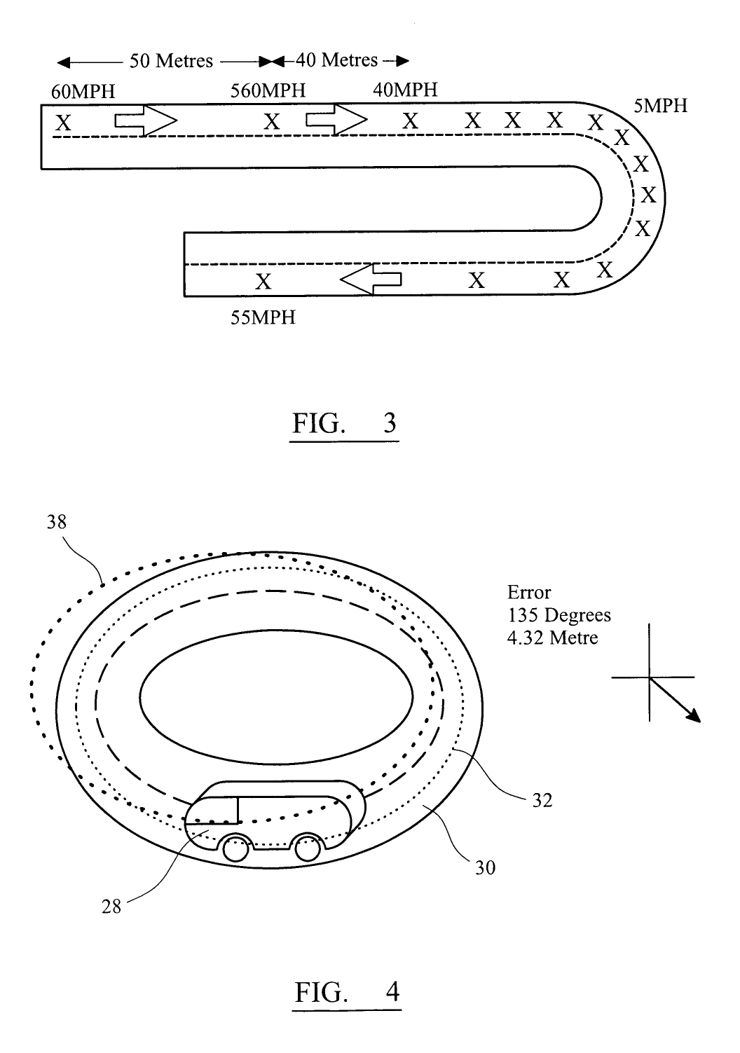

FIG. 3 is a schematic representation of the method of collecting data used in the present invention;

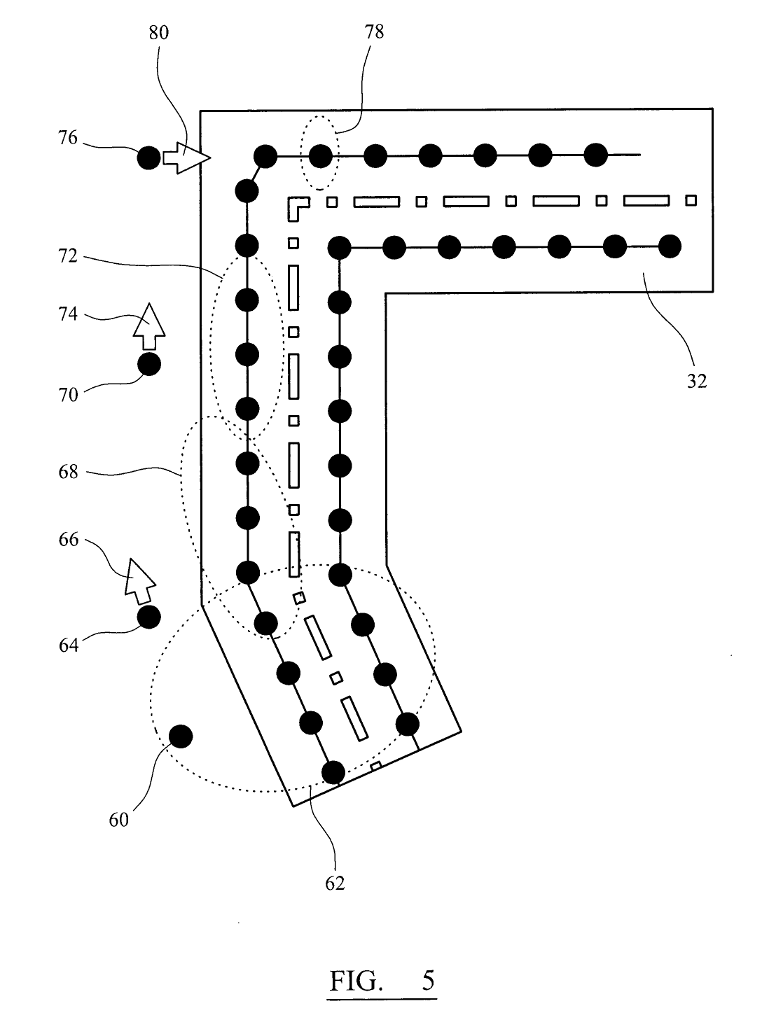

FIG. 4 is a schematic representation of the determination of the error correction factor used in the present invention;

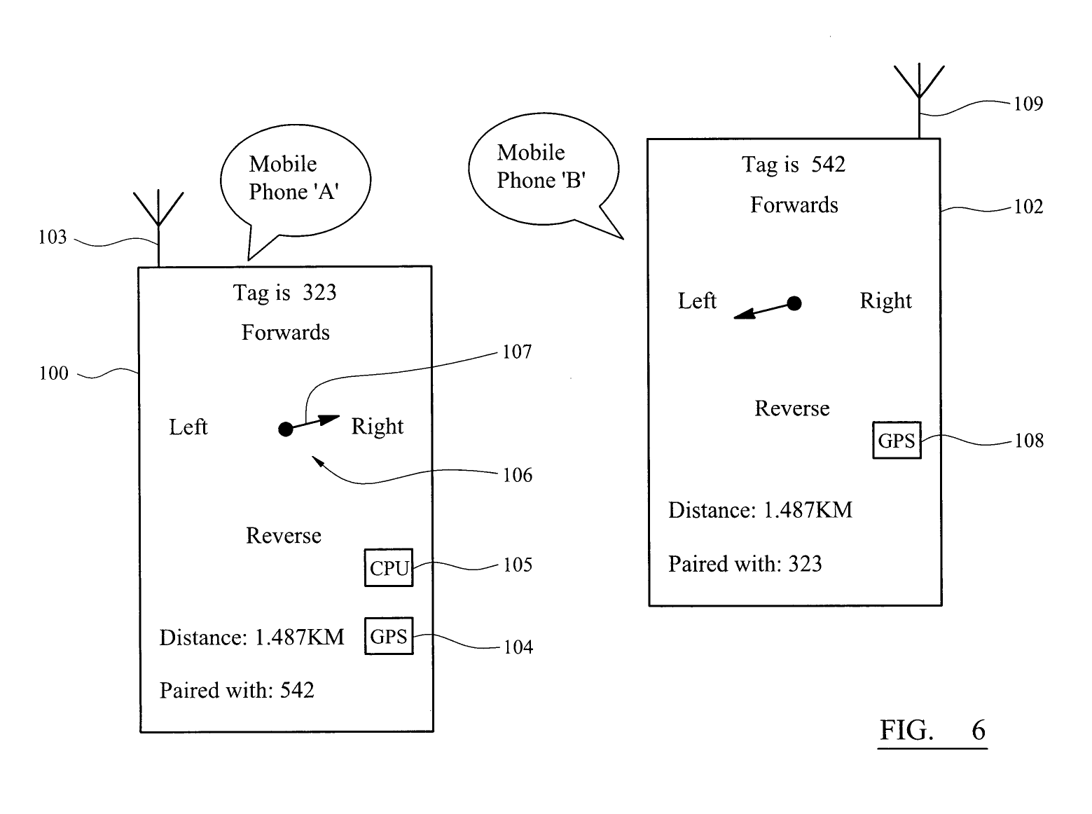

FIG. 5 is a schematic representation of the determination of the route being taken as used in the present invention; and

FIG. 6 is a schematic representation of an apparatus of a further aspect of the present invention.

Referring to FIG. 1, the apparatus used in the method of the present invention can utilise known apparatus as follows. A mobile sensing unit 10 includes a GPS receiver 12 that receives a GPS signal to estimate the location of the mobile sensing unit 10. The unit 10 also includes a GPRS transmitter that transmits data to a fixed GPRS transmitter/receiver 16. The GPRS transmitter 14 of mobile sensing unit 10 can typically also act as a receiver, although in the example shown in FIG. 1, only the transmitting function is required in order to operate the method of the present invention. The data received by the fixed GPRS transmitter/receiver 16 is transmitted, via the internet 18, to a processor/server 20, which is used to calculate an error correction factor.

Upon instruction from processor/server 20, via Internet 18, the fixed GPRS transmitter 16 transmits the correction factor data to a differential GPS 22. The differential GPS 22 has a GPS receiver 24 (equivalent to the GPS receiver 12 of mobile sensing units 10) and a GPRS receiver 26. In the example shown in FIG. 1, the GPRS receiver 26 is also able to act as a transmitter to transmit data to the processor/server 20 via fixed GPRS transmitter/receiver 16 and Internet 18. This transmitting function from differential GPS 22 is only required for embodiments that are tracking the movement of differential GPS 22.

In the method of the present invention, a vehicle 28, that has mounted on board a mobile sensing unit 10, travels along road 30 following a route 32 (step 34). Since the position of the mobile sensing unit 10 is fixed within vehicle 28 the position of route 32 within the width of road 30 is known to an accuracy of less than 50 centimetres. The GPS receiver 12 receives GPS signals (step 36) and is able to estimate its position at a plurality of positions 38 using standard GPS techniques (step 40). Due to variations in the speed of light as it travels through the earth's atmosphere and due to localised factors such as building, these positions are only estimated to an accuracy of +/−10 metres. These estimated positions 38 are temporarily stored in the mobile sensing unit before the data is transmitted using GPRS transmitter 14 (step 44). The estimated position is temporarily stored as a point in space (latitude, longitude and height) and these co-ordinate points are either transmitted as a single point (three numbers), and deleted from the temporary memory, or transmitted as a series of data points. The estimated position data is received by fixed GPRS transmitter/receiver 16 and passed to processor/server 20 via the internet 18.

In its simplest form the estimated position data 38 can be transmitted as simply a point in space without any additional information, such as the time of transmittal, the direction or speed of travel of the vehicle 28. The time at which the location is estimated does not need to be accurately provided as it can be estimated as approximately the time at which it is received by server 20 since this is sufficient for the purposes of estimating the GPS error factor.

When the estimated position data is received at server 20 (step 46) the estimated positions are compared with known routes (the locations of roads 30) to determine which road the vehicle 28 has been travelling along. This is a reasonably straightforward process since the estimated locations are accurate to around +/−10 metres and when a series of data points are grouped together it is readily apparent which road a vehicle has traveled along. Referring to FIG. 5, a first GPS estimated position 60 could be any one of the points on the road 32 contained within the ring 62. That is all of those points are within an expected error range (typically 10 m) of the first estimated point 60. When a second estimated point 64 is received by the server, it is clear that the vehicle is travelling in the direction indicated by arrow 66. It can therefore be assumed that the vehicle is travelling on the left hand side of the road (if in the UK or other left hand drive countries). Information relating to the direction of travel in a particular lane is held by the server. As a result point 64 must be one of the points contained in the ring 68, that is those on the left hand side of the road within 10 m of point 64. Similarly the third estimated point 70 could be any of the points contained within ring 72 because the vehicle is travelling a direction indicated by arrow 74 that is approximately the same as indicated by arrow 66. It is possible from this first three estimated data points to determine that the actual location of the vehicle is to the right of the estimated data point but it is not clear which of the point on the road contained within ring 72 is the actual location. Because the arrows 66 and 74 point in approximately the same direction, the points on the road contained within the rings 62, 68 and 72 are approximately linear. However, because the fourth estimated point has shifted to right, out of line with the other estimated points, and the shape of the left hand side of the road turns a corner this means that, since the distance that the estimated data point is from the actual position on the road is in all likelihood the same, the only point one the road 32 that is to the left of the fourth estimated point 76 and is at a similar distance as the data points in rings 68 and 72, is the point in ring 78. It is therefore possible to make an initial estimate of the error vector as the direction indicated by arrow 80 and the distance between points 76 and 78.

Alternatively this process can be viewed as initially calculating the error by simply subtracting the Euclidean distance from the current location point to the nearest road data point. Received data is then compared with the preceding data and trigonometry is used to determine the direction of travel and the current side of the road. A lookup method, using a genetic algorithm, is then used to find the best match to the closest lane. The received data is compared and subtracted from maximum and minimum North, East, West and South historic road/lane data. As a result as the vehicle changes its directions of travel the error is periodically reduced.

Once the estimated position data has been matched with a route at step 48, the estimated position data is divided into groups that match the known route to a similar degree (step 50). In open spaces it is typical that the correction factor remains constant over quite significant distances since the most significant factor perfecting the accuracy of the estimate of location using the GPS signals are the factors resulting from the earths atmosphere. However, in built up areas, where GPS signals can be reflected from buildings, the error factors can be significantly more localised.

For each of the series of estimated positions the vector needed to transform these estimated positions onto the known route is then determined. The accuracy is expressed as a vector, as shown in FIG. 4. This error vector is transmitted (step 54) to other differential GPS devices 22. At step 56, the differential GPS 22 uses the error correction vector to correct the estimated positions that it receives.

In order to make best use of the correction vectors, in particular in built up areas where error factors may be very localised, the GPRS receiver/transmitter 26 on differential GPS 22 transmits data relating to its estimated position via fixed GPRS transmitter/receiver 16 and internet 18 to server 20 and the error correction vector that is transmitted to the differential GPS is determined by its estimated locations.

Referring to FIG. 3, in order to reduce the volume of data that the GPRS transmitter 14 transmits to server 20, only data relating to the estimated position of the GPS receiver is transmitted. This data is transmitted with sufficient frequency that a complete picture of the journey that the vehicle is travelling can be determined. For example, the speed, acceleration, deceleration can all be easily determined from the data transmitted. The rate at which the data is stored for transmission is determined in relation to the speed of the vehicle and the distance traveled since the last data point was stored for transmission. When a data point has been stored for transmission and the vehicle continues to move, the distance that the vehicle has traveled is measured using the GPS readings and by calculating the distance between the present position and the position when the last data point was stored for transmission. When this distance (measured in metres) is equal to or greater than the speed that the vehicle is travelling (measured in mile per hour) the present position is stored for transmission. The process is then repeated for the next data point. This process results in a consistent stream of data being produced that is easily analysed. For example, the distance between two adjacent points, as it can be calculated by the server following receipt of the transmitted data, measured in metres is equal to the speed that the vehicle was travelling in miles per hour.

When the vehicle is travelling at a constant speed the data is stored for transmission at a constant rate with respect to time and this time interval is the same irrespective of the speed that the vehicle is travelling. As a result when the vehicle is travelling fast the data points are spread widely apart with respect to distance and a much closer together when travelling slowly. This is useful since when travelling at high speed the vehicle will be travelling in an relatively straight line. However, when the vehicle is travelling round a corner, and more data points are required in order to determine the shape of the road, the vehicle is likely to be travelling much slower and the tighter the turn, and therefore the more data points that are required in order to accurately match to a route, the slower the vehicle will be travelling and the more data points per unit of distance will be produced. It is therefore possible, whilst using a small volume of data, to produce an accurate representation of the route that a vehicle has taken.

Furthermore, in a vehicle tracking system, analysis of the data points allows other useful information to be determined. For example, a very simple visual analysis demonstrates acceleration and deceleration since when a vehicle is accelerating the time period between data being stored for transmission is longer than when the speed is constant. If the vehicle is accelerating at more than 0.44 ms⁻² then no data is stored since the distance traveled in metres never reaches the speed in miles per hour. Similarly, when the vehicle is decelerating the time between data being stored is shorter when travelling at a constant speed. Furthermore, the rate of acceleration and deceleration can be calculated to check if the vehicle's driver is accelerating and braking excessively hard, and with data that can be regarded as accurate to 50 centimetres it is possible to determine when a vehicle deviates slightly from its anticipated route, indicating that the vehicle is overtaking. As a result, it is possible to track driver behaviour that may be regarded as inappropriate if it is happening at an unacceptably high frequency.

With reference to FIG. 6, there is provided a first device 100 for indicating the direction to at least one second device 102. The devices are typically mobile communication devices such as GPS enabled mobile phones. The first device 100 has a receiver in the form of an antenna 103 with associated circuitry for receiving information relating to the location of the second device 102. This information is typically the longitude and latitude at which the second device 102 is presently located and is preferably in the form of an electromagnetic signal. The first device 100 also has location determining means preferably in the form of GPS receiver 104 for determining the location of the first device 100. The first device 100 further has calculating means preferably in the form of processor 105 for calculating the direction from the first device to the second device. The first device 100 also has indication means 106 for indicating the direction to the second device 102. The indication means 106 is preferably a screen for displaying an arrow 107 which points in the direction of the second device 102. A transmitter typically an antenna 103 with associated circuitry for transmitting information relating to the location of the first device 100 is also generally provided as part of the first device 100. The information may be the longitude and latitude of the first device 100 and is preferably in the form of an electromagnetic signal.

The second device 102 includes location determining means in the form of GPS receiver 108 and a transmitter in the form of antenna 109 with associated circuitry. The transmitter transmits location information of the second device 102 calculated by the GPS receiver. The device 102 could be a simple transmitting device with no display or information receiving function and be in the form of for instance a key ring. However, typically the device 102 will be another device with the same features as the first device 100.

The first device 100 is able to indicate the direction to a second device 102 by firstly receiving information relating to the location of the second device 102. This information is transmitted to the first device 100 either directly from the second device 102 or from a fixed GPRS transmitter/receiver or satellite (not shown). The first device 100 determines its own location using GPS receiver 104. The CPU 105 calculates from the received information and its own location, the direction from its own location to the second device 102. The first device then indicates this direction on a screen by means of an arrow 107 which is adapted to point in the direction of the second device 102. From the known locations of the first and second devices 100, 102 the first device 100 may also be adapted to calculate and display the distance between the devices. If the device 100 is fitted with an internal compass it is able to immediately point towards device 102 by determining which way it is pointing. However, without an internal compass, it is necessary for device 100 to move so that its direction of travel can be determined and the location of the second device indicated. Preferably the first device 100 is adapted transmit information relating to its location for every 0.5 meters of movement of the first device 100 such that the second device 102, using the method outlined above, may determine the location of the first device 100 to within 50 cm.

It will be appreciated by persons skilled in the art that the above embodiments have been described by way of example only, and not in any limitative sense, and that various alterations and modifications are possible without departure from the scope of the invention as defined by the appended claims. For example, the use of GPRS as described above could be any other mobile telephone data transfer technique or any other method of transmitting and receiving data between devices. The fixed GPRS transmitter/receiver could be more directly connected to processor/server 20 than by attachment via the Internet 18.

The means for transporting the mobile sensing unit 10 could be any vehicle that travels along a known route, for example a train. Although ideally only co-ordinates are transmitted, it may occasionally be necessary to transmit other small volumes of data, for example, an initial time of sending the first data packet after which the time of all further data packets can be determined as a result of the regular sending of this data.

In the example where a vehicle is being tracked using a differential GPS 22, this function could be undertaken using a standard GPS that does not receive error correction data. For example, the GPS unit equivalent to differential GPS 22 could simply transmit data relating to its estimated position and server 20 could use the error factor that it is calculating to accurately determine where the vehicle carrying that GPS receiver was at that moment.

It should also be noted that the above described method without the inclusion of height data in the GPS data that is sent to the server although this is likely to slightly reduce the accuracy. The differential GPS receiving device could be located outside of a vehicle. The above described method of calculating errors can be used to provide a correction factor to a GPS device contained in a mobile phone.

It should further be noted that the estimated position data sent could be vector data. After an initial position is determined the remaining data could be sent as vector data, that is that the second estimated position is indicated by a direction and distance from the first and this is repeated for each subsequent position.

The first device 100 in FIG. 6, may indicate the direction to a plurality of other devices simultaneously by use of a plurality of arrows.

1-41. (canceled)

42. A method of determining an error factor for a differential global positioning system, comprising the steps of:
receiving data transmitted from at least one device travelling along at least one of a plurality of known routes, the data relating to a plurality of assumed positions of the device on the basis of global positioning system signals received by global positioning system receiver in said device;
comparing a plurality of said assumed positions of the device with said plurality of routes to determine the route that most closely corresponds with the plurality of assumed positions; and
comparing a plurality of said assumed positions with the determined route to calculate an error factor.

43. A method according to claim 42, further comprising one or more of the following features:
a) transmitting said error factor to differential global positioning system devices;
b) wherein the error factor is expressed as a vector; and
c) causing said device to travel along at least one of a plurality of known routes and transmitting data relating to a plurality of assumed positions of the device on the basis of global positioning system signals received by said global positioning system receiver in said device.

44. A method according to claim 43, further comprising either or both of the following features:
a) transmitting at least one of said data and said error factor via a mobile telephone network; and
b) storing data relating to said position of said device at known intervals and said transmitted data excludes data relating to the speed and direction that the device is travelling.

45. A computer program for determining an error factor for a differential global positioning system, the program comprising:
first computer code for receiving data transmitted from at least one device travelling along at least one of a plurality of known routes, the data relating to a plurality of assumed positions of the device on the basis of global positioning system signals received by global positioning system receiver in said device;
second computer code for comparing a plurality of said assumed positions of the device with said plurality of routes to determine the route that most closely corresponds with the plurality of assumed positions; and
third computer code for comparing a plurality of said assumed positions with the determined route to calculate an error factor.

46. A computer program according to claim 45, further comprising either or both of the following features:
a) fourth computer code for transmitting said error factor to differential global positioning system devices;
b) wherein said third computer code calculates the error factor as a vector.

47. A computer program according to claim 46, further comprising fifth computer code for transmitting at least one of said data and said error factor via a mobile telephone network.

48. A method of tracking a global positioning system receiving device, comprising the steps of:
receiving a plurality of global positioning system signals relating to a position of said device;
storing data relating to said position of said device at known intervals; and
transmitting said data relating to said position of said device, said transmission including Cartesian coordinates indicating said position and excluding data relating to the speed and direction that the device is travelling or including vector coordinates indicating said position relative to a previous position and excluding Cartesian coordinates indicating said position.

49. A method according to claim 48 further comprising one or more of the following features:
a) wherein said intervals are intervals in time;
b) wherein said intervals are determined dependent upon the distance traveled from the last stored position relative to the speed;
c) wherein said data is transmitted via a mobile telephone network; and
d) wherein said global positioning system receiving device is a differential global positioning system receiving device.

50. A method according to claim 49 further comprising either or both of the following features:
a) wherein said intervals are determined such that data is stored when the distance from the last stored position measured in metres is equal to or greater than the speed measured in miles per hour; and
b) wherein said differential global positioning system receiving device uses an error factor determined according to the method of claim 42.

51. A first device for indicating the direction to at least one second device, the first device comprising:
a receiver for receiving information relating to the location of a second device;
at least one location determining device for determining the location of said first device;
at least one calculating device for calculating the direction from said first device to said second device; and
at least one indication device for indicating said direction.

52. A first device according to claim 51, further comprising one or more of the following features:
a) wherein said first device further comprises a transmitter for transmitting information relating to the location of said first device;
b) wherein at least one said indication device comprises at least one screen displaying an arrow which points in the direction of said second device;
c) wherein said first device comprises a mobile communication device; and
d) wherein at least one said location determining device comprises a global positioning system.

53. A first device according to claim 52, further comprising one or more of the following features:
a) wherein said transmitter and said receiver comprise a single unit;
b) wherein at least one said indication device further indicates the distance between said first and said second devices;
c) wherein said global positioning system comprises a differential global positioning system; and
d) wherein said first device comprising said global positioning system is tracked according to the method of claim 48.

54. A first device according to claim 53, further comprising one or more of the following features:
a) wherein said differential global positioning system uses an error factor determined according to the method of any of claim 42;
b) wherein said differential global positioning system uses and error factor determined using a computer program according to claim 45; and
c) wherein said first device comprising said differential global positioning system is tracked according to the method of claim 49.

55. A method of indicating the direction from a first device to at least one second device, the method comprising the steps of:
a first device receiving information relating to the location of a second device;
determining the location of said first device;
calculating the direction from said first device to said second device; and
indicating said direction.

56. A method according to claim 55, further comprising one or more of the following features:
a) the step of said first device transmitting information relating to the location of said first device;
b) wherein said first device receives information from said second device.
c) wherein said first device receives information from at least one fixed GPRS transmitter/receiver; and
d) wherein said first device receives information for every 0.5 meters of movement of said first device.

57. A method according to claim 56, further comprising one or more of the following features:
a) wherein said first device transmits information to said second device;
b) wherein said first device transmits information to at least one fixed GPRS transmitter/receiver; and
c) wherein said first device transmits information for every 0.5 meters of movement of said first device.
